(19) United States
(12) Patent Application Publication
(10) Pub. No.: US 2005/0056162 A1
(43) Pub. Date: Mar. 17, 2005

(54) Cake germ shield

(76) Inventors: Jane M. Milligan, Toronto (CA); Kyle Davis Milligan, Toronto (CA); Sarah K. Milligan, Toronto (CA); Michael J. Milligan, Toronto (CA)

Correspondence Address: ROBERT L . WESTELL, 36 EGLINTON AVENUE WEST, SUITE 706, TORONTO, ON, M4R 1A1, CA

(21) Appl. No.: 10/940,667

(22) Filed: Sep. 15, 2004

Related U.S. Application Data
(60) Provisional application No. 60/502,937, filed on Sep. 16, 2003.

(51) Int. Cl. A47J 43/00

(52) U.S. Cl. 99/645

(57) ABSTRACT

A germ shield for a cake is designed to mount candles which may be blown out by the celebrant. The shield is transparent and preferably made of non-combustible, non-noxious plastic in the event of contact with a candle flame. Preferred plastics are oriented polystyrene (OPS) or polyethylene terephthalate (PETE).

This application claims priority based on Provisional Application 60/502,937, filed Sep. 16, 2003.

This invention relates to a germ shield for a cake on which candles are mounted to be blown out by the cake celebrant. The shield is transparent to allow the cake to be viewed and the shield has sides, and a cover shaped to support candles, (usually birthday or anniversary candles) thereon. The shield thus supports burning candles while the birthday (or anniversary) celebrant blows them out. The cover thus keeps the cake relatively germ free in spite of the celebrant's blowing. After the candles are blown out the shield may be discarded before cutting and serving the cake, which has been kept comparatively germ free. In one alternative the positions on the shield for supporting the candles has a slit or aperture so that a pin or spike on the candle or the candle itself may be embedded in the cake. The slit or aperture therefore allows some of the ‘blower' s’ germ laden breath through to the cake but this is small relative to the contamination that would occur if the shield were not there.

The material of the shield should be such as will not catch fire or emit noxious or unpleasant fumes. Thus many plastics are unsuitable. I prefer to use oriented polystyrene (OPS) or polyethylene terephthalate (PETE) which materials do not support combustion nor make fumes.

In drawings which illustrate the embodiments of the invention:

FIG. 1 is a perspective of the shield;

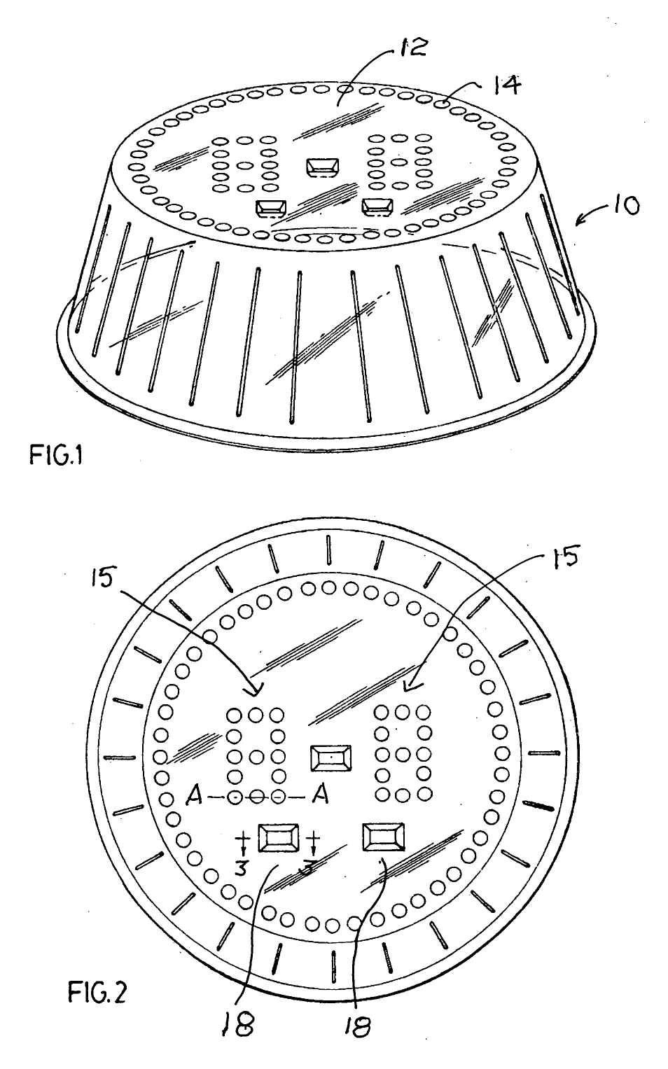

FIG. 2 is a plan view thereof;

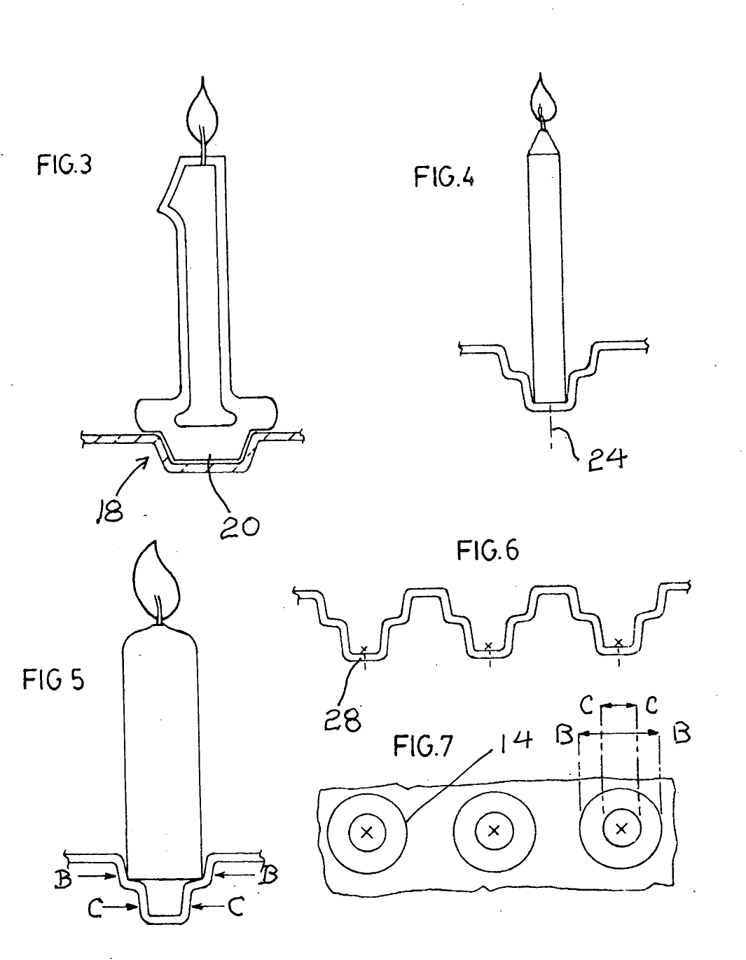

FIG. 3 shows a flat candle support and the receptacle. The latter is illustrated along the lines 3-3 of FIG. 2;

FIGS. 4 and 5 are candles seated in recesses shown here in vertical section;

FIG. 6 is a vertical section along the line A-A of FIG. 2, and

FIG. 7 is a plan view of the three recesses along the line A-A of FIG. 2.

In the drawings, FIG. 1 shows a germ shield 10 for covering the top and sides of a cake which is round in plan and which tapers somewhat from bottom to top. The shield is transparent so that the cake however decorated or inscribed is visible. As many shapes for cake and the shield may be made as desired. Each may be square, rectangular or any other shape to suit the shape so the shield will loosely complement the cake.

Since candles will be burning and then blown out above the shield the material of the shield should be flame inhibiting and/or should not be able to maintain combustion nor give off unpleasant or poisonous odors if exposed to flame. I prefer to use oriented polystyrene (OPS) or polyethylene terephthalate (PETE) which I find will not sustain combustion and will not give off unpleasant or dangerous odors if exposed to flame.

The pattern of candle upwardly facing recesses illustrated in FIGS. 1 and 2 may be varied in any way desirable. The candles for use with the shield of FIGS. 1 and 2 may be of several types such as those hereinafter described, may be of one type only, or may be differently arranged from the arrangement shown.

Thus the shield shown in FIGS. 1 and 2, for example, shows on the shield top 12 a peripheral circle of upwardly facing candle receptacles 14, each of which will be shaped to support a candle.

Thus the receptacles 14 are preferably shaped as shown in section in FIG. 4 or 5 having a stepped recess in larger diameter B-B or smaller diameter C-C, as shown in FIGS. 4, 5 and 7, to respectively suit the size of candle supported. The same type of receptacle, or another, may be provided for each receptacle at the two rectangles 15 of 13 receptacles shown in FIGS. 1 and 2, each receptacle 14 preferably similar to those shown in FIGS. 4, 5, 6.

In addition to the common type of candle, as shown in FIG. 4, and the broader type as shown in FIG. 5, the candle holder 18 of FIG. 3 may have a narrow laterally extended base 20, and support an upwardly extended flat thin member and candle which, below the candle flame displays a numeral as shown in FIG. 3. Three receptacles are shown on flat holder 18.

Referring to the common type of candle of FIG. 4, this may be mounted by friction if the dimensions of the receptacle are suitable or may be mounted in another conventional way.

Referring again to FIG. 4, if the candle is provided with a downwardly extending prong or spike 24, and the shield is weakened or slit, then the prong or spike may be thrust through the shield and embedded in the cake. Alternatively the prong or spike may be omitted and the candle embedded in the cake. Although the hole or slit will interfere with the integrity of the shield, it will still provide a shield against a large proportion of the germ laden breath of the blowing celebrant.

As shown in FIG. 5 the larger diameter candle may be received in a wider portion B-B of a receptacle 14. Or the wider candle may be supported by a spike, not shown, extending below the candle and pressed into the cake. In other words all of the alternative mounting means of FIG. 4 are available for the candle of FIG. 5 and also for the candle of FIG. 3.

FIG. 6 schematically represents a vertical section along the line A-A of FIG. 2 and the symbols 28 represent the possible slits at the bottom of receptacle 16.

In operation a shield of whatever shape, preferably of OPS or PETE, is decorated with candles installed by one of the means described, is placed over the cake and the celebrant is invited to extinguish the candles. After she or he has blown and done this, the shield is withdrawn, having saved the cake from a substantial amount of the celebrant's germs and the shield may be destroyed.

As previously stated the shield may be otherwise shaped to suit a differently shaped cake. The candle receptacles may be arranged in different patterns. The receptacles may be otherwise shaped.

1. Transparent cake shield comprising top and sides,
said top being adapted to support candles for combustion,
said shield stopping the passage therethrough of a large proportion of blown air.

2. Transparent cake shield as claimed in claim 1, wherein the material of the shield is flame inhibiting.

3. Transparent cake shield as claimed in claim 1, wherein the material of the shield is not able to maintain combustion.

4. Transparent cake shield as claimed in claim 1, which does not give off unpleasant or poisonous odors if exposed to flame.

5. Transparent cake shield as claimed in claim 1, wherein the shield is made of oriented polystyrene or polyethylene terephthalate.

6. Transparent cake shield as claimed in claim 1, wherein the shield defines upwardly facing recesses which are stepped to fit different candle diameters.

7. Transparent cake shield as claimed in claim 6, wherein said recesses are stepped down with a decreasing diameter to hold a second candle size.

8. Transparent cake shield as claimed in claim 1, having at least one laterally elongated upwardly facing recess.

9. Transparent cake shield as claimed in claim 1, wherein slits or weakened areas in the shield allow a spike or candle to penetrate to support a candle on the cake.
